(19) United States
(12) Patent Application Publication
(10) Pub. No.: US 2016/0210618 A1
(43) Pub. Date: Jul. 21, 2016

(54) SYSTEM AND METHOD FOR UTILIZING RANDOM AND NON-RANDOM BASED OCCURENCES FOR PAYOUTS ON FINANCIAL INSTRUMENTS

(71) Applicant: SLDR, Inc., Alexandria, VA (US)

(72) Inventors: Courtney A. Pace, Paris (FR); Jeffrey K. Brown, Miami, FL (US); Russell B. Pace, Alexandria, VA (US)

(21) Appl. No.: 15/085,224

(22) Filed: Mar. 30, 2016

Related U.S. Application Data
(63) Continuation of application No. 14/581,933, filed on Dec. 23, 2014.
(60) Provisional application No. 62/140,839, filed on Mar. 31, 2015.
(60) Provisional application No. 61/921,128, filed on Dec. 27, 2013.

(51) Int. Cl. G06Q 20/38; G06Q 40/02; G07F 17/32; G06Q 40/06

(52) U.S. Cl. CPC G06Q 20/38; G06Q 40/06; G06Q 40/025; G07F 17/329

(57) ABSTRACT

Disclosed is a debt repayment lottery/game system and method that allows a pool of players with existing loan debt such as student loans, mortgages, personal loans, credit card debt, automobile loans, boat loans, plane loans, investment loans, and other such debt. The winning payout is made to a third party versus the actual winner. Winner selection is based on various random and non-random factors. Each player is required to pay a fee that may be monetary or non-monetary to play in the lottery or other game. Such fees, or otherwise raised funds, are aggregated and pooled and are used, in part, to directly pay down the outstanding debt. There may be multiple winners depending on the amount of debt owed not necessarily the pool size. A safeguard or fail-safe mechanism prevents the player from purchasing more entries than debt owed.

### CROSS-REFERENCE TO RELATED APPLICATION

The present application claims the benefit of the filing date of U.S. Provisional Application No. 62/140,839 filed Mar. 31, 2015, and is a continuation of U.S. application Ser. No. 14/581,933 filed Dec. 23, 2014, the disclosures of which are hereby incorporated herein by reference.

### FIELD

The disclosed embodiments relate generally to a system and method of supporting a lottery program or other similar game or contest for the repayment of debts. More particularly, the disclosed embodiments relate to a system that allows users in debt to purchase lottery tickets or play other games, and awards the proceeds of the lottery ticket sales or other game participation fees or other sourced funds which contribute to a prize to a randomly, or not randomly, selected user by depositing the proceeds directly to the user's debt creditor.

### BACKGROUND

Debt is becoming an ever-growing concern. For example, outstanding U.S. student loan balances continue to reach new highs year after year. These outstanding balances have an adverse effect on our economy, as high monthly payments impact the credit of students, thus affecting their ability to buy homes, cars, and other consumer products. Moreover, many loans end up in default, compounding these negative consequences, both to the lenders and the overall economy. These problems are not unique to the student loan market. As government initiatives to help have fallen short, the industry is ripe for a market-based solution to mitigate such adverse effects.

Current debt repayment systems/games have many problems and shortcomings. For example, there are no safeguards to ensure that the participants are in fact in debt. Also, proceed money is not used from ticket sales or other participant entrance fees to directly pay down the winner's outstanding loan balances. Further, these systems may be only offered only throughout a single state.

Thus, there remains a need in the art for a secure lottery system or other similar game to allow those who have outstanding loans to aggregate funds or buy tickets in a lottery, or otherwise enter a payoff pool, wherein the pool's winning payment is applied directly to reduce the outstanding balance of the winning contestant's loan.

### SUMMARY

The present invention provides for an apparatus and method for generating a lottery, or another type of game, wherein the lottery's winning payment is applied directly to reduce the outstanding balance of a winning contestant's loan. The system includes various safeguards for preserving the integrity of the lottery or game.

While some examples below refer to outstanding student loans, it should be apparent to those in the art that the current system and method could be for a lottery for any type of debt (e.g., car loans, home mortgages, credit card debt, healthcare costs, corporate debt and the like) while remaining within the scope of the present disclosure.

The present invention utilizes a specialized computer made for a very specific purpose, namely, this first specialized computer typically is from a lender such as, but not limited to, FSA or FAFSA, Sallie Mae, Freddie Mac servers, that provide information and data on debts such as student loans, mortgages, car loans and the like. Further, this specialized computer controls another machine, namely a second specialized computer or the so-called repayment lottery computer system. The repayment lottery computer system receives selected information from the other first specialized computer at FSA or FAFSA, Sallie Mae, Freddie Mac and other government lending agencies or lending institutions and the like to improve its functioning by obtaining among other things selected data on debts and hence the first specialized computer controls the potential pool of debts to be paid.

Transformation of a selected number of debts determined by the repayment lottery computer system through random and non-random methodologies transforms debts into paid off loans or credit.

This is an unconventional means of paying off loans through a gaming system. In addition the payoff or winnings of the game is not given to the winner, but is paid directly to the creditor having the specialized machines (computers) yielding a useful application for debt reduction. Further to this unconventional system and method is a fail-safe where the debtors are limited as to the amount of money they can put forth to enter the game. This fail-safe ensures that the debtors do not accumulate even more debt by paying more to enter the game than what they actually owe to the lenders.

Furthermore, a contestant has to qualify before being allowed to play a game. The qualification is unrestrictive in nature unlike other programs and the debt must again be confirmed by information in the first specialized computer before any payout is made. This qualification, however, is not restrictive or discriminatory in nature; rather it has universal appeal and applicability to all debtors or borrowers under any debt program. To participate proof that one has an outstanding debt is the sole requirement. Contestants may be individuals, group of individuals, companies, corporations, partnerships and other organizations. This sole requirement to enter is in stark contrast to strict and onerous eligibility criteria for other types of government loan relief or peer-to-peer programs. The present invention only allows for the winning proceeds to be used to pay down existing debt. The payout is not made to the winner but directly to the lender, on behalf of the winner. The winning borrower never physically receives the proceeds associated with any prize.

Again, to prevent participants' overspending, material financial loss, and/or overall abuse of the system, a fail-safe component for contestant limits the amount he/she can invest in the game less than, for example a threshold amount, 50% of the loan is an example. There is a winner for every game and in some cases multiple winners depending not on the amount of the pool per se, but taking into account the amount owed by the winner. For example, every time a pool is closed at least one winner is selected.

Again, there may be multiple winners. A waterfall payout structure guarantees the entire sum of the marketed prize pool is paid out for every game even if the winner's loan balance is lower than the prize pool. The system continues to pay out and makes more winners for the pool. The prize pool may be supplemented by private institutions, existing lenders, banks, employers, university or governmental agencies, and the like. The system may also have a tracking feature used to monitor how much of a loan balance is owed as that amount may change even after a contestant has entered the game. The actual amount of the potential payout applicable to a winner may automatically change throughout the course of the game as a result of unique factors exogenous to the gameplay itself—e.g., if the student's outstanding loan balance varies. This creates a sufficiently large number of theoretically possible variable payout combinations.

The foregoing objects are achieved and other features and advantages of the present invention will become more apparent in light of the following detailed description of exemplary embodiments thereof, as illustrated in the accompanying drawings.

### BRIEF DESCRIPTION OF THE DRAWINGS

In the drawings, wherein similar reference characters denote similar elements throughout the several views:

FIG. 1 shows a schematic block diagram depicting one embodiment of the system and method.

FIG. 2 shows a schematic flow diagram of a general overview of a system and method for a debt repayment, such as a lottery, according to one embodiment.

FIG. 3 shows a schematic flow diagram of one embodiment of Phase I of the system and method as shown in FIG. 2.

FIG. 4 shows a schematic flow diagram of one embodiment of Phase II of the system and method as shown in FIG. 2.

FIG. 5 shows a schematic flow diagram of one embodiment of Phase III of the system and method as shown in FIG. 2.

FIG. 6 shows a schematic block diagram showing hardware and software components of a computer system on which the system of the present disclosure could be implemented.

### DETAILED DESCRIPTION

The invention will now be described in detail with reference to the accompanying drawings. The present invention relates to a system and method for debt repayment. In the following examples, a lottery system and method is used for illustration. The scope of the invention is not necessarily limited to a lottery and may be utilized in other contests, games, quizzes and the like or any combination thereof. The use of the lottery example is in no means meant to limit the scope of this invention. In typical loan repayment systems, debtors, whether individuals, groups of individuals corporations or the like will pay more than what amount was borrowed. In the present invention, debtors actually pay less than what was borrowed without filing for bankruptcy, asking for loan forgiveness and without affecting negatively credit.

Current debt repayment systems or games or programs have many shortcomings. Most debt repayment systems and programs provide options to refinance existing debt by replacing outstanding debt with loans bearing a lower interest rate, but again give the debtor a larger amount to pay off than what was borrowed. A few repayment systems and programs may actually provide total relief, but have very strict and burdensome qualification standards that apply to only a small subset of borrowers, and again the payoff amount on the loan is much larger than the amount borrowed.

Traditional private loans are typically more expensive than government loans and are often made for the purpose to provide additional leverage, and not debt reduction. Although loan-refinancing systems have existed for a long time and still serve as an option for borrowers looking to reduce the periodic interest cost on their loans, none of these systems to date have proven to be an effective measure to reduce debt without adversely affecting credit ratings, or adding more to the amount to payoff.

Technological innovation has enabled new underwriting and risk distribution techniques, prompting a new wave of private alternative lending networks, commonly known as peer-to-peer lending platforms (P2P). P2P platforms, however, still only act as a means for a borrower to access cheaper or additional loans, and like traditional refinancing strategies, do not provide the borrower with a significant and immediate principal reduction and emancipation from the overall debt burden. Particularly in the case of student loans, government sponsored programs do provide for some temporary and permanent debt relief, but they are very discriminatory and limited in their applicability and benefit. For example, “loan forbearance” programs temporarily suspend all or some of a borrower's required periodic payments. Such decision to suspend the obligations often comes entirely at the mercy of the lender and only during periods of certain defined financial hardship of the borrower. For mandatory forbearances, the rules are very restrictive and exclusionary in terms of which borrowers can benefit. The US student loan programs limit mandatory forbearances to people in certain professions (such as teachers who qualify for other loan forgiveness programs) and to those whose monthly student loan payments are at least 20% of their monthly income.

Moreover, the temporary suspension, which is capped in at 12 months per period, only applies to principal payments while interest continues to accrue (and compound if unpaid) during the forbearance period. “Loan deferment” mechanisms (for example, those inherent in the Direct Student Loan, Federal Family Education Loan, and Perkins Loan programs) provide more relief to the borrower from his/her monthly loan payments, to the extent that for government subsidized loans, no interest is charged to the borrower (interest continues to accrue and compound for other loans during such deferment period).

For non-subsidized loans, interest continues to accrue, as in the loan forbearance system. The reprieve from interest on subsidized loans is permanent in the sense that interest costs for such deferment period are never charged, but at the end of the deferment period, interest will resume its accrual schedule and the borrower still remains obligated to repay the loan balance plus any accrued interest. Loan deferment programs have even stricter qualification standards than the forbearance programs, thus making them applicable to an even smaller subset of borrowers. For example, only the following subset of borrowers may be eligible for federal deferment programs: a) current students enrolled at least half-time in approved post-secondary education, career school, or rehabilitative training for the disabled, b) those experiencing unemployment or economic hardship, and c) military service personnel during periods of active duty or the 13 months immediately following active duty. True loan “forgiveness” or “discharge” programs whereby the borrower is permanently relieved of paying any remaining amounts on their loan do exist, but only a limited subset of borrowers may benefit and only after very onerous qualification periods. For example, borrowers who have been full-time teachers for five consecutive years at schools servicing low income families may qualify under the Teacher Loan Forgiveness Program. Also, the US National Institute of Health allows forgiveness for certain US citizens and residents who are full time NIH employees or have worked for at least two years doing qualified research for a US nonprofit or government entity. Additionally, certain full-time employees of other qualifying public service organizations may qualify for certain loan forgiveness only after they have made 120 timely monthly payments—i.e., only after 10 years of successful loan repayment. Additionally, borrowers may benefit from government-sponsored relief under their Federal Direct Loan and FFEL Program loans in the extremely rare cases of total permanent disability or death, some bankruptcies, school closings, false or fraudulent loan certification by school or via identity theft. In summary, existing government sponsored loan relief programs are often temporary in nature, do not apply broadly to most borrowers, and require those who might qualify to pass very strict and onerous eligibility criteria and thresholds to participate.

In contrast, the present invention is not restrictive or discriminatory in nature; rather it has universal appeal and applicability to all borrowers under any debt program. To participate, all one has to do it prove that they have an outstanding debt. Other peer-to-peer type systems (for example, Rolling Jubilee) try to take advantage of market dislocations by pooling charitable donations to buy large pools of loans from the market at fractions of their underlying costs/face values and then “writing off” such loans to the benefit of the underlying borrowers. In such systems, because the loans are bought for pennies on the dollar, only borrowers in default under severely discounted loans can benefit. Again, the nature of this system restricts broad applicability to all borrowers. Furthermore, such systems do not allow borrowers to take active roles in trying to improve their personal balance sheets. Moreover, such write-off systems have yet to prove any broad efficacy with regards to student loans—because borrowers generally are not relieved of their student loan obligations during a bankruptcy situation, lenders almost never dispose of their loans at such discounted prices that make such systems as Rolling Jubilee economically viable. Unrelated to the payoff of debts, other systems and games do provide jackpots or prize pools. For example lotteries and raffles exist in various forms across the country, but to our knowledge, none exist with such limited purpose as to help its participants pay down debt. In contrast to a state lottery, for example, the present invention only allows for the winning proceeds to be used to pay down existing debt and unconventionally proceeds for the winner are never given to the winner. Instead the winnings go directly to the lender. In fact, as a safeguard to prevent misappropriation, the winning borrower never physically receives the proceeds associated with any prize—such proceeds are paid directly to the lending institution of record on the winner's outstanding debt. Moreover, current jackpot-based games do not provide for a waterfall-based payout structure for multiple winners and thus do not guarantee that all promised prize money would be paid out after each game. For example, in the typical state or multi-state lottery, prize monies may be split amongst multiple winners by ways of the pot-based “jackpot” prize and several smaller fixed payouts. And in the case of multiple contestants that have all participated with the same winning entry, the jackpot prize may be split evenly amongst such participants. While the potential payout may be known at the time the bet is sold, in such contests, there is no guarantee that there will actually be a jackpot winner or that all of the prize money will be distributed in the contest, for example if the winning ticket is never sold. By contrast, in the present invention, there is a winner for every game every time a pool is closed. Other games and contests may have fixed known payouts. For example, some include pari-mutual betting contests upon taking of the last bet and closing of the pool. Still none of the current debt repayment systems have a variable payout structure or the ability to systematically alter the payouts as a result of unique exogenous factors that only become relevant once the game has commenced. In the present invention, such exogenous factors exist in the distinct amount of outstanding debt held by each participant in the game. These exogenous factors combine with the special purpose nature of the system and help repay debt to create a sufficiently large number of theoretically possible variable payout combinations.

The present invention includes a selection system which may identify and rank multiple winners and a waterfall payout structure which guarantees that all advertised prize money from a given pool will be paid out as winnings.

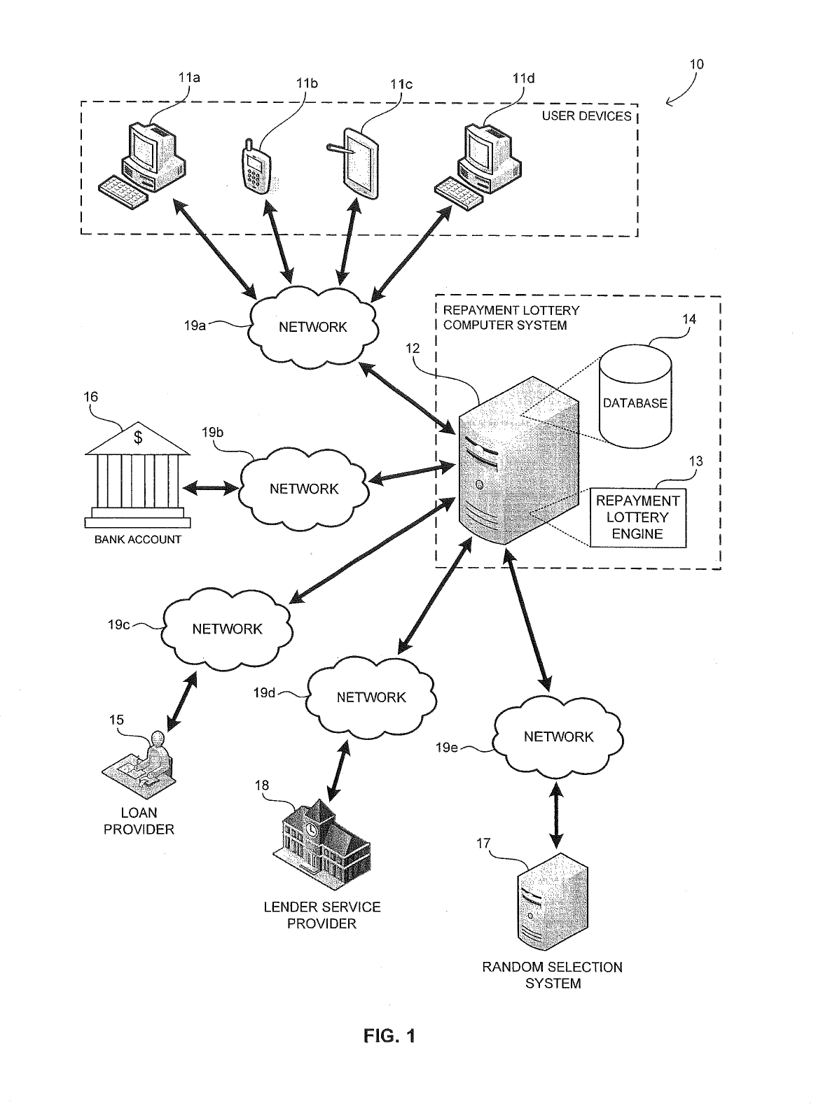

Turning now to FIG. 1, shown is a schematic block diagram depicting the system 10 for the lottery for debt repayment. When the term lottery is referenced in this description, it includes, but is not limited to a lottery, a game, a contest, a quiz, and any combination thereof. The system 10 comprises a repayment lottery computer system 12, which includes a database 14 and a repayment lottery engine 13. Engine 13 includes, but is not limited to, a processor, a server, software, programming code, a computer, and any combination thereof. While FIG. 1 shows a database 14 stored locally in the computer system's 12 memory, the database 14 may comprise any type of database, such as a web-based (e.g., cloud-based) database, a locally stored database, or any combination thereof. In the disclosed repayment lottery computer system 12, the database 14 could include multiple databases and/or the repayment lottery engine 13 could include multiple engines. The repayment lottery engine 13 is configured to transmit web site pages and messages through networks 19a-19e to control the operation and security of the lottery.

The networks 19a-19e could be any type of network, such as a local area network, a wireless network (e.g., internet, wireless public and/or private networks, cellular system) or any combination thereof. The networks 19a-19e can comprise a single network or any number of networks. For example, networks 19a-19e could all be the same network, separate networks, or any combinations. Depending on the embodiment, additional networks may or may not exist, such as, but not limited to, external databases, corporate sponsors, holding entity, and any combination thereof.

For the purposes of this description, it is contemplated that the scope of the invention includes in person ticket sales or in person interaction for the lottery, game, or contest. This lottery, game or contest includes but is not limited to general knowledge quizzes, random winner selection, games of skill, predicting uncertain future events, or other such contests.

Lottery contestants may participate in the lottery for debt repayment by using user devices 11a-11d to communicate, via the network 19a, with the repayment lottery engine 13. User devices 11a-11d may comprise any type of user device capable of communicating with the engine 13 such as a personal computer, laptop, mobile phone, tablet, etc. Lottery contestants and registered users are used interchangeably for the purpose of this description. Lottery contestants and registered users include but are not limited to the following entity or entities: indebted person or people, indebted organization or organizations, indebted company or companies and the like. The terms lottery contestant and registered users may be used interchangeably in the present description depending upon the embodiment described. Other benefactors, such as but not limited to family or non-family members, parents, employers, other sponsors, and the like, may purchase tickets on behalf of the indebted entity.

The repayment lottery engine 13 includes a functionality for communicating with the user devices 11a-11d and acquiring user input relating to contestant information, including loan information (balance on loan amounts, identities of loan providers 15, loan identification/tracking numbers, etc.). In cases where the lottery is for repayment of school loans, each contestant may be required to input information relating to the educational institution associated with the loan. The repayment lottery engine 13 includes a registration functionality for using the contestant information to register contestants. The registration process will assign, and include, unique identifiers associated with each registrant. These may include an email address, username, IP address, a password, and any other unique identifiers consistent with current or future login and information security protocols. Depending on the embodiment, verification of contestant information may or may not be done in advance of ticket purchase.

In order to improve accuracy and deter fraudulent activity, the registration functionality is configured to authorize each contestant by verifying the accuracy of the inputted loan information. The registration functionality could communicate with a lender service provider 18 or a credit agency or other third party agency to receive verification. For example, in cases where the lottery is for repayment of school loans, the registration functionality could communicate with the U.S. Department of Education's Office of Federal Student Aid agency (FSA or FAFSA) or any database or organization or agency managing such a database to confirm the inputted contestant information. Depending on the implementation, user errors, typos, and the like do not necessarily invalidate the selection process. For example, in one embodiment, initially not every piece of inputted information needs to exactly match to confirm the debt. Preferably there is a confirmation of a student's outstanding debt, for example, and of the student's creditor institution related to that debt. It is contemplated that detailed specifics may be confirmed and reconciled for winners before payout to the creditor or third party.

In some embodiments, in addition to or instead of communicating with the lender service providers, the engine 13 could communicate with the loan provider 15 directly. Also, the loan provider 15 and the lender service provider 18 could be the same entity. An initial requirement for a ticket purchase or entry in the contest or game is confirmation of a debt. There could be other requirements for a ticket purchase or entry in the contest or game, including, but not limited to, answering questions, providing information, or registering with or providing certain consents to another website. In some embodiments, the contestant could provide non-monetary consideration in order to enter a contest.

Upon verifying the inputted contestant information and registering the contestant, the engine 13 could store the contestant information in the database 14. In some embodiments, the engine 13 has a synchronous communications linkage with loan providers 15 and/or the lender service provider 18 to enable contestants' loan information stored in the database 14 to be monitored, confirmed, and updated in real time. For example, when a contestant pays off a portion of the loan to a loan provider 15, the loan information stored in the database 14 reflects this decrease in loan balance.

The engine 13 includes a ticket sales functionality that could be inaccessible to unregistered users in order to deter fraud. When a contestant becomes registered, the contestant is provided access to the ticket sales functionality. Thus a contestant could use a user device 11a-11d to communicate with the ticket sales functionality to purchase, for example, lottery tickets. The ticket sales functionality could operate as a point of sale terminal to receive payment from a contestant in exchange for a lottery ticket. Each lottery ticket could be assigned a unique identifier. The lottery ticket may be an electronic ticket (e.g., an electronic display of the unique identifier for presentation to an interface associated with the contestant's user device 11a-11d) or a tangible lottery ticket displaying the unique identifier (e.g., a physical ticket that is mailed to the contestant). The number or dollar amount of lottery tickets a contestant could purchase could be limited. In one embodiment, this limit could be a percentage of the contestant's overall loan amount outstanding. For example, if a contestant had $100,000 in student loans outstanding and the dollar amount for ticket purchases was limited to 1% of a contestant's total loan amount per year, a contestant would only be able to purchase a total of $1,000 in tickets for that year and would be prevented from buying more tickets beyond that limit. Said more generally, The maximum total dollar amount allowed to be invested by any individual indebted contest in a given year equals:

CTP<=K*ADB, where
CTP=the cumulative $ amount of all ticket purchases in a School Year (defined as September 1 through the following August 31),
K=a factor, less than 0.5, which will remain constant throughout a given School Year,
ADB=Average Debt Balance, determined by taking the arithmetic average between the combined opening balance of an individual's reported debts at the beginning of the School Year and the combined balance of the individual's same debts at the individual's initial registration for a given pool or contest.
   Benefactors of that student could be allowed to continue purchases on the contestant's behalf.

The engine 13 could establish multiple lottery “pools,” in which case a lottery ticket establishes the contestant's participation in a particular lottery pool. When a contestant buys a lottery ticket for a particular pool, the engine 13 stores in the database 14 associative information linking the particular contestant to the contestant's lottery ticket unique identifier. The engine 13 also stores in the database associative information linking each pool to all of the ticket unique identifiers participating in the pool. The several lottery pools could have various payoff amounts or no pre-specified payoff amount at all. For example, a first pool could have a payoff amount of $10,000, a second pool could have a payoff amount of $20,000, a third pool could have a payoff amount of $30,000, a fourth pool could have a payoff amount of $40,000, a fifth pool could have a payoff amount of $50,000, and a sixth pool could have no pre-specified payoff amount. In some embodiments, the ticket cost for the various pools may differ (e.g., a cost to buy a ticket in the fifth pool is greater than the cost to buy a ticket in the first pool) while in other embodiments, the ticket cost is the same for every pool. Different embodiments could offer pools with different odds to better match varying contestant risk profiles. The lottery could include multiple pools, coexisting contemporaneously or not, having the same payoff amount, but with other differing characteristics (e.g., ticket prices). When one pool with a designated payoff amount is closed, a new pool could be automatically opened with similar characteristics, and the contestant who attempted to purchase a ticket in such closed pool may purchase tickets in the newly opened similar pool or any other pool. Additional pools may be added to the system, and a pool's payoff amount could be adjusted over time to meet changing demand. Additionally, pools may have a temporal element such that they may have a scheduled closing time or deadline regardless of the number of tickets that have been purchased for that pool. In this case, the payoff amount may be a function of the number of tickets sold by the scheduled closing time or deadline. Furthermore, pools may include both a specified payoff amount and a temporal deadline. Depending on the embodiment, the system may automatically open up an identical pool upon the closing of a specific pool, such that the ticket holder may have confidence that he/she can buy into, and not get shut out of, a certain pool profile. This process may happen automatically and would be seamless from the contestant's perspective.

Each pool could have a “designated pool amount” equal to the pool's payoff amount plus additional costs. The additional costs could include the expense, royalties, and profit for creating and supporting the lottery, and could also include contribution to a “Super Player” drawing, which is explained in further detail below. The additional costs could equal a percentage of the pool's payoff amount. For example, a pool with a payoff amount of $40,000 may have a designated pool amount of $44,800, equal to the payoff amount, plus 10% of the payoff amount ($4,000) to go towards expense, royalties, and profit, plus 2% of the payoff amount ($800) to go towards the Super Player drawing. Information regarding each pool's payoff amount and designated pool amount could be inputted into the system 12 by a system administrator. Ticket sales and other sources of funding could generate money to satisfy the designated pool amount.

The various pools are overseen by the engine 13, which includes a tracking functionality for tracking each pool's ticket sales and/or the amount of time left until the pool closes. The tracking functionality maintains a running toll of the ticket sales for each pool to determine when the gross proceeds from the ticket sales, or other proceeds, reaches the pool's designated pool amount (if there is a specified pool amount). For example, if each ticket costs $10 for a pool with the designated pool amount of $44,800 and no cutoff time, then when the 4,480^{th} ticket is sold the tracking functionality could determine that the gross proceeds form the ticket sales equals the pool's designated pool amount. In turn, the pool will be closed. Additionally, the tracking functionality maintains a timer for each pool to determine how long a particular pool has been open to new entries, and counts down the amount of time until the deadline. This functionality may notify the potential contestants how much time remains for them to enter a particular pool (if there is a deadline). The engine 13 may also allow for automatic notifications to be sent to potential contestants when a pool's funding is approaching its pool amount or when a pool's temporal deadline is approaching. For pools that include a specified potential payoff amount and a temporal deadline, the engine 13 will include a tracking functionality which both maintains (a) a running toll of the ticket sales for each pool to determine when the gross proceeds from the ticket sales, or other proceeds, reaches the pool's designated pool amount and (b) a timer for each pool to determine how long a particular pool has been open to new entries, and counts down the maximum amount of time remaining until the deadline (the engine 13 may track both (a) and (b) for all pools, regardless of whether they have an official pool limit, a temporal deadline, or both). In this case, the engine 13 would determine when either the pool limit or the temporal deadline has been reached and, upon concluding that either event has happened, will then close the pool. When a particular pool is closed, the engine 13 precludes contestants from purchasing any more tickets for that pool. The engine 13 could include a depositing functionality that deposits the proceeds from the ticket sales into a bank account 16. Depending on the embodiment, this may happen before or after a pool is closed. In one embodiment, money or funds will be deposited upon receipt.

As shown in FIG. 1, the deposit may take place electronically over a network 19b. Deposits can be made real time as money is collected. This includes transferring or placing funds in various types of accounts.

Upon closing the pool, the engine 13 initiates selection of a pool winner. A pool winner could be selected through any method of randomly or non-randomly determining a winning ticket out of a pool of tickets. In the particular embodiment shown in FIG. 1, the selection of a pool winner is achieved by a functionality of the engine 13 communicating with a random selection system 17. In doing so, the engine 13 retrieves from the database 14 the associative information linking the pool to all of the participating unique identifiers. The engine 13 transmits a message containing all of the participating unique identifiers to the selection system 17. The selection system 17 randomly and/or non-randomly selects a unique identifier and sends a message identifying the unique identifier to the engine 13. In some embodiments, the selection system 17 could randomly select a unique identifier by ranking the participating unique identifiers in a list and sending a message containing the ranked list to the engine 13. In such cases, when the engine 13 receives the ranked list of participating unique identifiers, the engine 13 identifies the unique identifier ranked first in the list as the winner. Depending on the embodiment, there may be additional winners. In all cases, the total Pool Payoff Amount (PPA) from a specific contest will be defined as:

PPA=P₁+P₂+P₃+ . . . +Pₙ
Pₙ=the total payoff paid to satisfy contestant N's debts
P₁=Min(PPA, DB₁)
P₂=Min(PPA-P₁, DB₂),
P₃=Min(PPA-Σ(P₁ . . . P₂), DB₃)
Pₙ=Min(PPA-Σ(P₁ . . . _{Pn-1}), DBₙ)
Min (X,Y)=the minimum of X or Y
DBₙ=the total currently outstanding Debt Balance of all debts registered within the system by contestant N, as of the payoff record date (i.e X days before the scheduled payment distribution date)

While FIG. 1 shows a selection system 17 that is located externally from the system 12, in other embodiments the selection system 17 could be a component of the system 12 itself. For example, the selection system 17 could be a functionality of the engine 13.

The engine 13 includes a winning unique identifier functionality wherein, upon the engine 13 identifying the selected unique identifier, the engine 13 uses the associative information linking the unique identifier to a contestant to retrieve from the database 14 the identity of the winning contestant. The winning unique identifier functionality could also retrieve from the database 14 the winning contestant's loan information. Upon identifying the winning contestant and retrieving his or her loan information, a verification functionality of the engine 13 sends a verification message to the lender service provider 18 and/or to the loan provider 15 and/or to another verification body to confirm the current loan information and verify the outstanding loan balance. The engine 13 includes a notification functionality such that when contestant's identify, information, and loan balance are verified, the notification functionality notifies the winning contestant that he or she has won the pool (e.g., by sending an email to the winning contestant) and requests confirmation from the winning contestant. Depending on the embodiment, the contestants, for example, are not required to confirm after they have won. In one implementation, the system may simply notify them, and not even ask them to confirm receipt of notice. Other implementations of this embodiment are also possible.

When the engine 13 receives the winning contestant's confirmation, or once the winner has been determined and notified, depending on the embodiment, the engine 13 may initiate a money transfer in the pool's payoff amount from the bank account 16 to an account associated with the winning contestant's creditors 15. The engine 13 also determines whether the winning contestant's loan balance is less than the pool's payoff amount. If so, then the engine 13 determines another winning contestant to receive the difference between the pool's payoff amount and the first winning contestant's loan balance. In some embodiments, when identifying the other winning contestant, the engine 13 prompts the selection system 17 to select another unique identifier. In cases where the selection system 17 sends a ranked list of unique identifiers to the engine 13, then the winning number functionality identifies the unique identifier that is listed next in the ranked list. The engine 13 then performs again the above described information retrieval, verification, notification, and transfer steps for the other winning contestant. After transferring money to the other winning contestant's creditors, the engine 13 again determines whether any balance remains in the pool's designated payoff amount, and if so, repeats the above described steps until the balance of the pool's designated payoff amount has been reduced to zero.

In some embodiments, the lottery includes a “Super Player” drawing. The drawing could have a large payoff value (e.g., $250,000) and could be held at selected times throughout a year. As described above, the Super Player drawing can be funded by depositing a predetermined percentage from the proceeds of other pools' ticket sales into the Super Player fund. It could also be funded through methods other than ticket sales. Depending on the embodiment when a contestant purchases a lottery ticket for a particular pool, the engine 13 could automatically generate a Super Player ticket with an assigned unique identifier for the contestant. The steps of randomly selecting a unique identifier, verifying the winning contestant's information, receiving confirmation from a winning contestant, and depositing funds could all be similar to the steps described above with reference to the other lottery pools. Super Player tickets may also be purchased separately independent of other lottery pools. Any registered contestant or user may purchase Super Player tickets. Those tickets are open to previous players in other lotteries or newly registered players or users. Accordingly, depending on the embodiment, the generation of a Super Player ticket does not depend only upon purchase of tickets in another pool. Alternative embodiments of this configuration for Super Player tickets are also available.

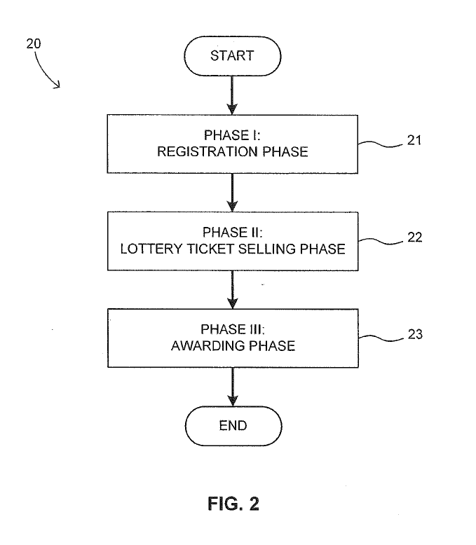

FIG. 2 is a flow-chart showing the processing steps carried out by the system 12. As shown, the process includes three phases, Phase I 21 is the registration phase, Phase II 22 is the lottery ticket selling phase, and Phase III 23 is the awarding phase.

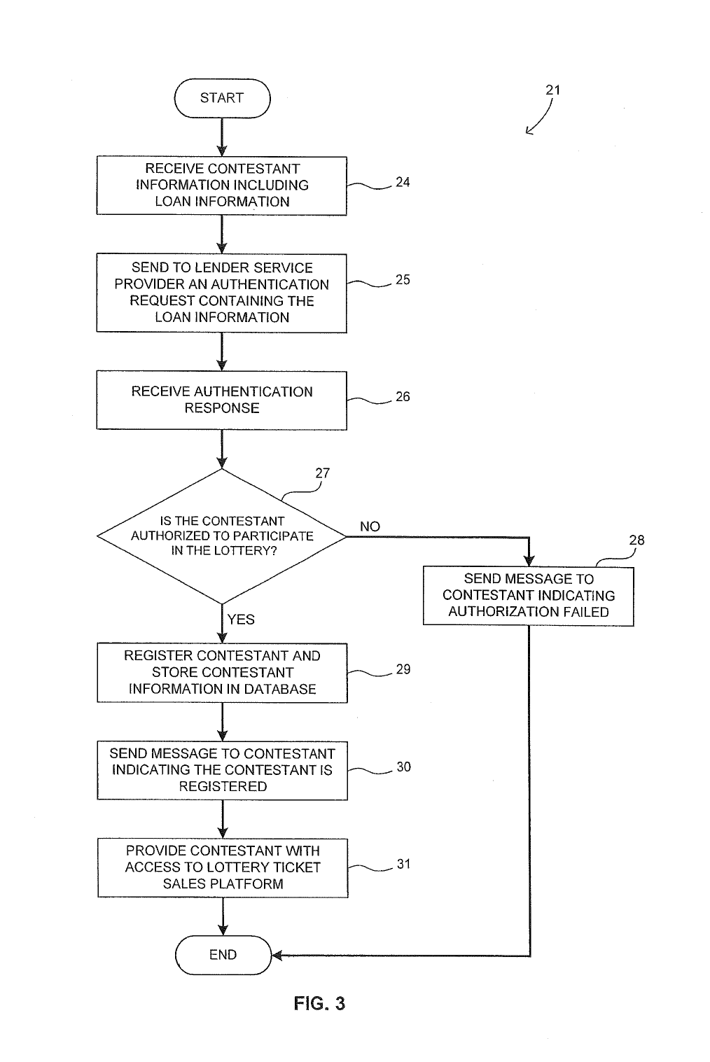

In Phase I, the repayment lottery engine 13 receives contestants' loan information to register contestants. The engine 13 could register a contestant only upon verifying the contestant's identity and loan information. Once a contestant has become registered, the contestant is provided access to the ticket sales platform. A benefactor may also be able to purchase tickets on a contestant's behalf once that contestant has become registered. Phase I is described in further detail below in connection with FIG. 3. Re-registration is not required. Depending on the embodiment, students, for example, do not need to register each time they want to purchase a ticket. Once they register, they are qualified to purchase with periodic, such as annual or biennial, reviews by the system to ensure they still have outstanding debt. Loan amounts will always be re-verified before payout. Each registrant will be assigned a unique identifier, which may include an email address, username, IP address, a password, and any other unique identifiers consistent with current or future login and information security protocols. Once stored, the repayment lottery engine 13 may use such user information (for example, a registrant's email address) to automatically advise and recruit the user when new pools or contests become available and/or to send the user targeted marketing material.

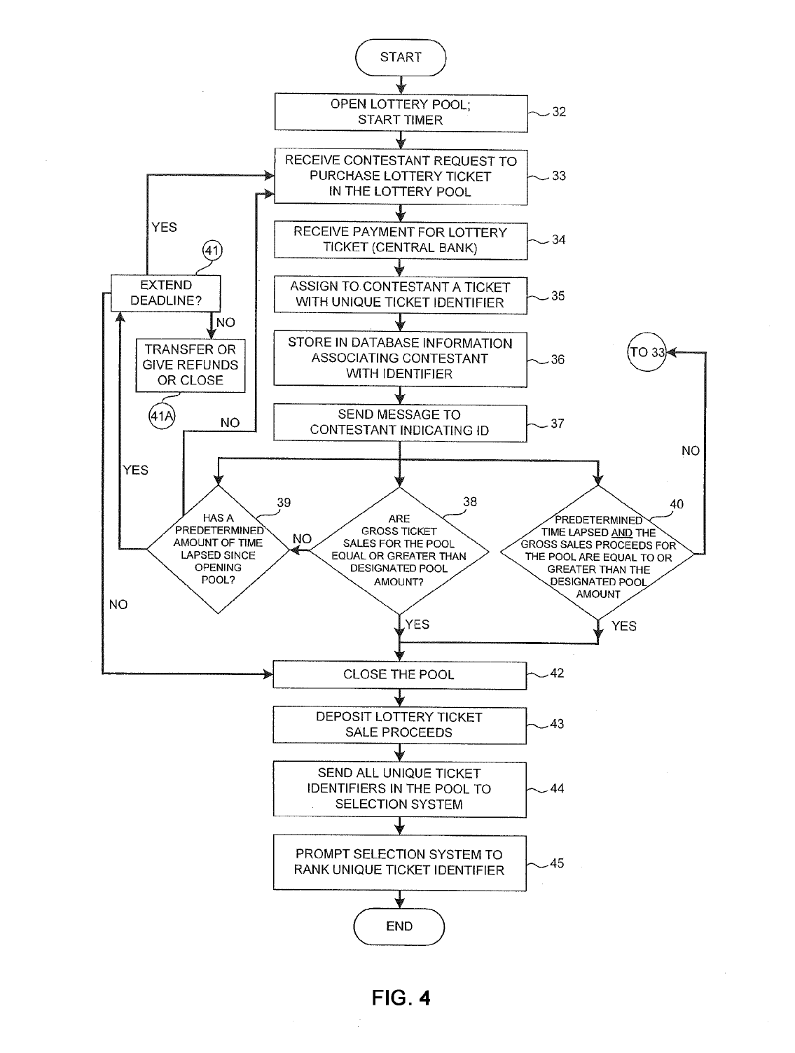

In Phase II, the repayment lottery engine 13 oversees various pools, and for each pool receives payment from registered contestants in exchange for lottery unique identifiers. When a pool's gross ticket sale proceeds reach the pool's designated amount or the temporal deadline has passed, such as, but not limited to a time period in minutes, hours, days, months or other time related events such as a holiday, anniversary, birthday, or the like, the engine 13 closes the pool and deposits the ticket sale proceeds into a bank account 16 associated with a particular pool. The engine sends all of the participating unique identifiers to a random selection system 17. The engine 13 causes the random selection system 17 to select a winning unique identifier of the participating unique identifiers. In some embodiments, the random selection system 17 randomly ranks the participating unique identifiers and sends a list of the ranked unique identifiers to the engine 13. Phase II is described in further detail below in connection with FIG. 4.

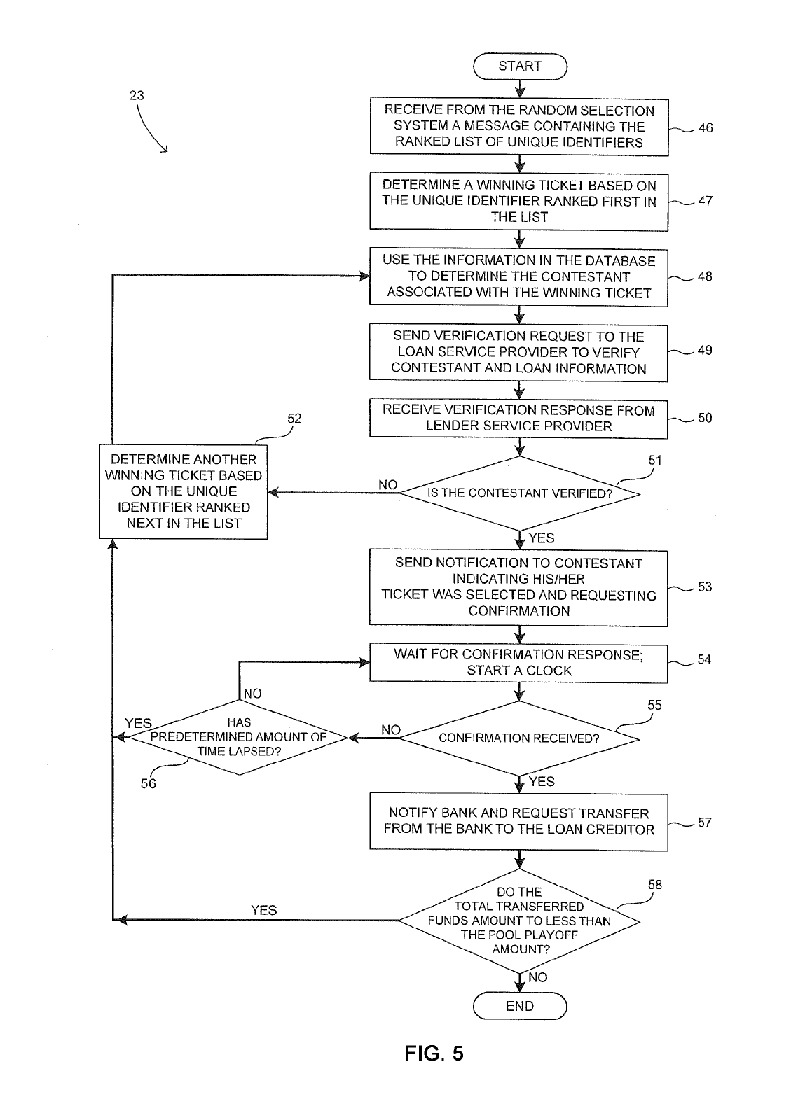

In Phase III, the engine 13 determines a winning unique identifier based on information received from the random selection system 17. In embodiments where the random selection system 17 sends to the engine 13 a list of ranked unique identifiers, the engine 13 determines the winning unique identifier based on the list (e.g., by determining whatever unique identifier is first in the list). The engine 13 identifies the contestant associated with the winning unique identifier and verifies his or her loan information. Upon the verification, and, depending on the embodiment, upon receiving a confirmation from the winning contestant, the engine 13 causes a transfer from the bank account 16 associated with the pool to the winning contestant's loan provider 15. Phase III is described in further detail below in connection with FIG. 5.

FIG. 3 is a flow-chart showing processing steps carried out by the system during a registration phase. In step 24, the repayment lottery engine 13 receives contestant information, including loan information. In step 25, the engine 13 sends a message to a lender service provider 18 or other verification body containing the received loan information (and evidence of the contestant's permission to access such information) with a request to authenticate the loan information and additional information. Depending on the embodiment, provisions are made for the borrower, such as a student, to give permission to pull his loan records. Thus the system may not necessarily only “confirm” information, but also “extract” as well. In one implementation of this embodiment, the consent/permission is received from the borrower when he registers and agrees to terms and conditions of use of the system and method of debt repayment.

For example, the engine 13 can request the lender service provider 18 to verify that the received input matches information in the lender service provider's 18 database relating to the contestant's identify, loan identification number, creditor's name, current loan balance, loan payment history, etc. In step 26, the engine 13 receives an authentication response from the lender service provider indicating whether or not the contestant is authenticated (e.g., whether the received input matches the information in the lender service provider's database). In step 27, the engine 13 processes the authentication response to determine if the participant is authorized to participate in the lottery. If the response indicates that the verification failed, then the engine 13 moves to step 28 and a message is sent to notify the contestant that the registration process failed. If the response indicates successful authentication, then the engine 13 proceeds to step 29, and the engine 13 registers the contestant and stores the contestant and loan information in the database 14. In step 30, the engine 13 notifies the contestant of the successful registration, and in step 31, the engine 13 provides the contestant with access to the ticket sales platform.

In order to deter fraud and ensure that the system is used only by users with current outstanding loans and/or to prevent gambling abuse, the engine 13 could limit a registered contestant's access to the ticket sales platform. For example, the contestant could be allowed to access the ticket sales platform only for a limited amount of time (e.g., a predetermined number of hours, days, or weeks) or for a limited number of transactions (e.g., one ticket sales transaction) or for a limited dollar amount of ticket purchases (e.g., a certain percentage of the contestant's overall outstanding loan balance) before the contestant's access is blocked by the engine 13. When the contestant's access becomes blocked and the contestant would like to regain access to the ticket sales platform, the contestant could reenter his or her contestant information for the engine 13 to contact the lender service provider 18 again and authorize he contestant information. In cases where a contestant's access to the ticket sales platform is for an extended period of time (e.g., a month) or related to a monetary limit (for an amount of ticket sales), the engine 13 could establish log-in credentials (e.g., a username and password) so the contestant could log-in to the ticket sales platform by entering the credentials. A contestant's access to the ticket sales platform could also be blocked in terms of the pools which the constant may view. For example, if a contestant's outstanding loan balance is for $10,000 then the contestant may be precluded from accessing ticket sales platforms for pools with a $100,000 payoff amount. Depending on the embodiment, the number of ticket sales may be limited for other purposes as well. It is also within the scope of this invention to optionally give additional tickets to registered contestants based on quantity of tickets purchased, or other factors.

FIG. 4 is a flow-chart showing processing steps carried out by the system during a ticket sales phase. In step 32, the engine 13 opens a lottery pool and starts a timer. In step 33, the engine 13 receives a request from a contestant to purchase a lottery ticket for the pool. In step 34, the engine 13 receives and verifies payment information for the lottery ticket, and in step 35, the engine 13 gives to the contestant a lottery ticket with an assigned unique identifier that has not yet been assigned to anyone participating in the particular pool. In step 36, the engine 13 stores associative information in the database linking the contestant with the lottery unique identifier. Step 36 includes, but is not limited to, other collected information, such as demographics, loan information associated or not associated with the contestant or registered user, and may or may not be information that ties directly to the contestant or registered user and not necessarily used as an identifier. Depending on the embodiment funds may be deposited immediately upon receipt. In step 37, the engine 13 sends to the contestant a message indicating the unique identifier (e.g., by displaying the unique identifier on a webpage via the contestant's user device 11a-11d interface, by sending an email message to the contestant containing the unique identifier, etc.). It should be understood that in the processing steps described herein, the contestant could purchase a plurality of lottery tickets, in which case the contestant would be assigned a corresponding plurality of unique identifiers. In step 38, the engine 13 aggregates the ticket sale proceeds and any other proceeds for the pool and determines whether the gross ticket sale proceeds for the pool are less than the designated pool amount, if any. If the sales proceeds are less than the designated pool amount, then the engine 13 loops back to step 33 and waits to receive more ticket sales requests. Depending on the embodiment the designated pool amount may be adjusted to a lower amount. In another embodiment, if the gross ticket sale proceeds for the pool are more than the designated pool amount the engine proceeds to step 42 and the pool is closed and then to step 43 where a new pool is opened.

FIG. 4 shows an embodiment wherein, if (a) a pool's designated pool amount has not been reached or the pool does not have a designated pool amount, and (b) the pool has been open for a predetermined amount of time, then the engine 13 could close the pool based on the temporal deadline. For example, the engine 13 could have a timer functionality for keeping track of an amount of time that has lapsed since the opening of the pool. If in step 38 the engine 13 determines that the gross ticket sale and other proceeds are less than the designated pool amount or if there was no designated pool amount, then it would move to step 39 and determine whether the predetermined amount of time has lapsed since the opening of the pool. Alternatively, step 38 and step 39 may be reached directly from step 37. Furthermore, step 37 may go directly to step 40. Step 40 determines whether a predetermined time has lapsed and if the gross proceeds for the pool are equal to or greater than the designated pool amount. If yes, then step 40 proceeds to step 42 and closes the pool. If no, then step 40 proceeds to step 33. If the engine 13 determines that the predetermined amount of time has lapsed as in step 39 (e.g., if six months has gone by and a pool winner has not been chosen), then in step 41 the engine 13 could close the pool based on such temporal deadline, transfer or give refunds as seen in 41A or extend the deadline. If the engine 13 closes the pool because a certain amount of time has elapsed since opening the pool, the engine 13 moves to step 42 and closes the pool's ticket sales platform. If the engine 13 chooses to extend the deadline, the engine 13 loops back to step 33.

If the gross ticket sales proceeds are not less than the designated pool amount, the engine 13 moves to step 42 and closes the pool's ticket sales platform. In step 43, depending on the embodiment, a new pool may open once the existing pool is closed. Such pool opening may be automatic once a pool with the same characteristics, such as but not limited to payoff amount, ticket price and the like, has been closed. In step 43, the engine 13 deposits the ticket sales proceeds into a bank account 16. In one embodiment, step 43 could happen as funds are raised, and this step is not limited to only when the pool is closed. In doing so, the engine 13 stores in the database 14 associative information associating the pool to the particular bank account 16. In step 44, the engine 13 retrieves from the database 14 all of the unique identifiers participating in the pool, and sends a message containing all of the participating unique identifiers to a random selection system 17. In step 45, the engine 13 prompts the random selection system 17 to rank the unique identifiers. In other embodiments, instead of ranking the unique identifiers, the random selection system 17 could select a winning unique identifier at random or not at random.

FIG. 5 is a flow-chart showing processing steps carried out by the system during an awarding phase. In step 46, the engine 13 receives from the random selection system 17 a message containing a list of all the participating unique identifiers in a randomly ranked order. In step 47, the engine 13 processes the list and determines a winning unique identifier based on whichever unique identifier is ranked first in the list. In step 48, the engine 13 processes the associative contestant information stored in the database 14 to identify the contestant linked to the winning unique identifier and to retrieve the winning contestant's loan information. In step 49, the engine 13 sends a verification request message to the lender service provider 18 requesting confirmation of the winning contestant's loan information (e.g., to verify the contestant's identity, the current loan balance amount, the creditor, etc.). In step 50, the engine 13 receives a verification response indicating whether the winning contestant's loan information is verified.

In step 51, the engine 13 determines whether the winning contestant's loan information is verified based on the verification response. Depending on the embodiment, initially the system verifies only that a loan is outstanding in the stated person or entity's name and with an associated creditor or institution. In one embodiment, upon identifying a winner, the system confirms specifics, including but not limited to outstanding balance and payment details and the like. If the verification response indicates that the contestant's loan information is not verified (e.g., if the winning contestant's identity cannot be authenticated, or if the loan balance equals zero) then in step 52 the engine 13 uses the list to determine a next winning unique identifier based on whichever unique identifier is ranked next in the list. The engine 13 then loops back to step 48.

If, in step 51, the engine 13 determines that the contestant's loan information is verified, then in step 53 the engine 13 sends a message to the winning contestant (e.g., an email message) notifying the winning contestant that his or her ticket was selected. Notification of the bank and requesting transfer from the bank to the loan creditor is illustrated in step 54. Depending on the embodiment, the engine 13 may determine whether a confirmation response has been received as shown in step 55. If a response has not been received, then the engine 13 may determine whether a predetermined amount of time has lapsed in step 56 since the sending of the message requesting the confirmation. If a predetermined amount of time has lapsed without receiving a confirmation response, then the engine 13 will move to step 52 and use the list to determine a next winning unique identifier and loop back to step 48. If the engine 13 does receive a confirmation response, then the engine 13 notifies the bank and initiates a transfer from the bank account 16 to an account associated with the winning contestant's loan provider 15 in an amount equal to the lesser of the payout amount or the winner's verified outstanding loan amount. Depending on the embodiment, confirmation is not needed and the engine may proceed directly. In notifying the bank and initiating the transfer in step 57, the engine 13 retrieves the associative information in the database 14 associating the particular pool with a bank account number for the lender provider 15. When initiating the transfer, the engine 13 could send to a server associated with the bank account 16 a message containing the bank account number, the amount of money to be transferred based on the verified loan balance amount, and account information associated with the loan provider 15.

In step 58, the engine 13 determines whether the amount deposited to the winning contestant's loan creditor is less than the pool's payoff amount. If the amount deposited is not less than the pool's payoff amount (i.e., if the entire balance of the pool payoff amount was deposited to the loan creditor) then the set of processing steps is complete. If, on the other hand, the amount deposited is less than the balance on the pool's payoff amount (i.e., if the winning contestant's balance on the loan was less than the pool payoff amount) then the engine 13 moves to step 52 and uses the list to determine a next winning unique identifier. Thus, the engine 13 will continue to identify and reward winning contestants until the entire pool payoff amount is used to pay off loans. Accordingly, the method ensures that the entire pool payoff amount is indeed used to pay off loans (e.g. any excess payout amount beyond the winner's verified loan amount is not paid to the first winner, but to the second winner and so on, if need be).

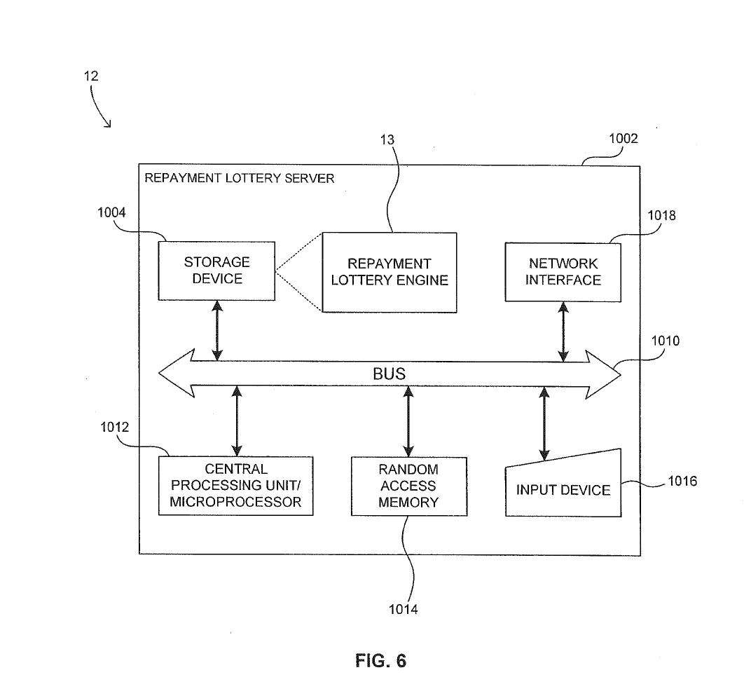

FIG. 6 is a diagram showing hardware and software components of a computer system 12 on which the system of the present disclosure could be implemented. The system 12 comprises a processing server 1002 which could include a storage device 1004, a network interface 1018, a communications bus 1010, a central processing unit (CPU) (microprocessor) 1012, a random access memory (RAM) 1014, and one or more input devices 1016, such as a keyboard, mouse, etc. The server 1002 could also include a display (e.g., liquid crystal display (LCD), cathode ray tube (CRT), etc.). The storage device 1004 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The server 1002 could be a networked computer system, a personal computer, a smart phone, tablet computer etc. It is noted that the server 1002 need not be a networked server, and indeed, could be a stand-alone computer system.

The functionality provided by the present disclosure could be provided by a repayment lottery engine 13, which could be embodied as computer-readable program code stored on the storage device 1004 and executed by the CPU 1012 using any suitable, high or low level computing language, such as Python, Java, C, C++, C#, .NET, MATLAB, etc. The network interface 1018 could include an Ethernet network interface device, a wireless network interface device, or any other suitable device which permits the server 1002 to communicate via the network. Again, the debt repayment system and method may be used to repay student loans, personal loans, car loans, corporate debt, healthcare bills and other such debts or any combination thereof. The CPU 1012 could include any suitable single- or multiple-core microprocessor of any suitable architecture that is capable of implementing and running the outcome prediction program 1006 (e.g., Intel processor). The random access memory 1014 could include any suitable, high-speed, random access memory typical of most modern computers, such as dynamic RAM (DRAM), etc. Having thus described the system and method in detail, it is to be understood that the foregoing description is not intended to limit the spirit or scope thereof. It will be understood that the embodiments described herein are merely exemplary and that a person skilled in the art may make any variations and modification without departing from the spirit and scope of the disclosure. All such variations and modifications, including those discussed above, are intended to be included within the scope of the disclosure.

1. A system for a debt repayment game, comprising:
a specialized first computer run by a government agency or lender controlling a second computer by the first computer selectively sending data and information concerning debt;
the second computer having a memory; and
a set of instructions stored in the memory that, when executed by the engine, cause the engine to:
receive, from user devices associated with a plurality of users, contestant information including information relating to each user's loan and/or loan provider,
register the plurality of users based on each user's contestant information and store such information,
provide the users with access to a sales platform,
receive, from the users via the sales platform, requests to purchase a plurality of tickets for a pool, wherein each of the plurality of tickets is assigned a unique identifier,
receive payment from the users,
assign to each of the plurality of users a ticket having a unique identifier,
determine whether gross sale proceeds for the pool are less than a designated pool amount,
close the pool based on determining that the gross sale proceeds for the pool are not less than the designated pool amount,
deposit sale proceeds for the pool into a bank account,
transmit to a random and non-random selection system a message containing the plurality of unique identifiers participating in the pool,
receive from the random and non-random selection system a random selection message,
determine a winning ticket of the plurality of tickets based on the random selection message,
determine a winning user of the plurality of users based on the winning ticket,
verify the winning user's information relating to the winning user's loan provider,
receive a confirmation from the winning user,
request a transfer from the bank account to a third party having an account associated with a loan provider, and transferring a winning amount not based on pool size but based on winner's debt owed in order to transform debt into a payoff amount or credit.

2. A method for providing a debt repayment game, comprising the steps of:
qualifying a contestant with debt in an unrestrictive manner;
collecting proceeds from at least one of the contestant, benefactors, or third party to create a winning pool amount that may be monetary or non-monetary;
limiting the amount of investment a contestant can place at risk in the game to less than 0.5 or 50% of the debt owed by the contestant to prevent contestant material financial loss and contestant overspending in the game;
selecting at least one winner based on random or non-random factors;
determining a payout amount based on winner's debt owed instead of the winning pool amount;
giving the payout amount to a third party lender instead of the winner where the winner never obtains the payout amount; and
making a waterfall payout structure to guarantee the entire sum of the winning pool amount is paid out for every game if the winner's debt is lower than the winning pool amount.

3. A non-transitory computer readable medium for providing a debt repayment game, comprising:
instruction code for receiving and storing, by an engine, from user devices associated with a plurality of users, contestant information including information relating to each user's loan and/or loan provider;
instruction code for registering, by the engine, the plurality of users based on each user's contestant information;
instruction code for providing, by the engine, the users with access to a sales platform;
instruction code for receiving, by the engine, from the users via the sales platform, requests to purchase a plurality of tickets for a pool, wherein each of the plurality of tickets is assigned a unique identifier;
instruction code for receiving, by the engine, payment from the users;
instruction code for assigning, by the engine, to each of the plurality of users a ticket having a unique identifier;
instruction code for determining, by the engine, whether gross sale proceeds for the pool are less than a designated pool amount;
instruction code for closing, by the engine, the pool based on determining that the gross sale proceeds for the pool are not less than the designated pool amount;
instruction code for depositing, by the engine, sale proceeds for the pool into a bank account;
instruction code for transmitting, by the engine, to a random selection system a message containing the plurality of unique identifiers participating in the pool;
instruction code for receiving, by the engine, a random selection message from the random selection system;
instruction code for determining, by the engine, a winning ticket of the plurality of tickets based on the random selection message;
instruction code for determining, by the engine, a winning user of the plurality of users based on the winning ticket;
instruction code for verifying, by the engine, the winning user's information relating to the winning user's loan provider;
instruction code for receiving, by the engine, a confirmation from the winning user; and
instruction code for requesting, by the engine, a transfer from the bank account to another account associated with the winning user's loan provider.

4. A method for providing a debt repayment game, comprising:
selecting for a game by a first computer from an unrestricted pool of players, each player having an existing loan debt; said first computer a specialized computer used in government or by financial institutions to generate loans;
a second computer controlled by said first computer through said selection, said second computer generating at least one winner from the pool of players by using at least one variable factor; and
paying a third party a winner proceeds based on the amount of debt owed by the at least one winner and not based on a winning pool amount; and said winner proceeds of the game for payment of said loan debt of said winner to transform debt into a payoff amount or credit.

5. The method of claim 4, wherein said each player in said restricted pool is required to pay an entrance fee, said entrance fee may be monetary or non-monetary or purchasing an item unrelated to the game.

6. The method of claim 5, wherein said fee is based on an amount of said loan debt for said each player, and financial conditions of said each player.

7. The method of claim 6, wherein said financial conditions include at least one factor consisting of employment status, annual wages, savings amounts, loan amounts, demographics, and any combination thereof.

8. The method of claim 4, wherein said at least one variable factor further includes selecting said winner based on random factors.

9. The method of claim 4, wherein said at least one variable factor further includes selecting said winner on a combination of random and non-random factors.

10. The method of claim 4, wherein said loan debt includes student loans, mortgages, personal loans, credit card debt, automobile loans, boat loans, plane loans, investment loans, healthcare costs, any other type of personal or consumer finance loan, corporate debt and any combination thereof.

11. The method of claim 4, wherein said loan debt is completely paid off.

12. The method of claim 4, wherein said loan debt is partially paid off.

13. The method of claim 4, wherein said loan debt is limited to Federal loans.

14. The method of claim 4, wherein said loan debt includes private loans.

15. The method of claim 4, further includes creating a series of winning payoff amounts based on the amount of said loan debt of said each player.

16. The method of claim 4, further includes creating a Super Pool established over time with winners likely selected less frequently.

17. The method of claim 4, further includes selecting the total amount of each said Winning Pool to be equal to the sum total of the following:
[PTP]+[ERP]+[SPC]+[AFS]=WP
wherein,
PTP is pre-tax payoff to said each player;
ERP is expense, royalties, and profits and is equal to [20 to 30]% of PTP;
SPC is the super player contribution and is equal to [0 to 5%] of PTP;
AFS is alternative funding sources which may equal 0 or more;
and WP is said Winning Pool amount.

18. The method of claim 4, further includes individually limiting a ticket purchase to an amount, for said each player, of total money invested or how many tickets are purchased per year using
CTP<=K*ADB, wherein
CTP=the cumulative amount of all ticket purchases in a School Year (defined as September 1 through the following August 31);
K=a factor, less than 0.5, which remains constant throughout a given School Year;
ADB=Average Debt Balance, determined by taking the arithmetic average between a combined opening balance of a reported player debt at the beginning of the School Year and a combined balance of the player's same debts at player's initial registration for a given pool or contest.

19. The method of claim 18, wherein said limiting ticket purchase or total money invested is based on an overall amount of loan debt outstanding for said each player.

20. The method of claim 4, further includes accepting donations for addition into said Winning Pool amount from individuals, individual companies, organizations, and any combination thereof; said donations include both monetary and non-monetary forms of payment.

21. The method of claim 4, further includes changing an entrance fee based on arbitrary factors not related to a formula or function based on the loan balance.

22. The method of claim 4, wherein the Winning Pool is a non-monetary prize.

23. The method of claim 22, wherein the non-monetary prize includes at least one of an employment interview donated by a corporation, a promise to fill an open position from a certain pool, mentoring, coaching, interview training, or any combination thereof.

24. The method of claim 4, further includes automatically opening a new pool immediately upon closing of an existing pool.

25. The system of claim 1, wherein the second computer is further configured to allow multiple winners from the same pool when the payoff amount exceeds the first winner's outstanding loan balance.

26. The system of claim 1, wherein the second computer is further configured to select a winner each time a pool is closed.

27. The system of claim 1, wherein the second computer is further configured to inform the contestant how close a pool is to being filled or closed.

28. The system of claim 1, wherein the second computer is further configured to recommend a certain pool or announce best odds for a given user profile.

29. A system for a debt repayment game, comprising:
a specialized first computer run by a government agency or lender controlling a second computer by the first computer selectively sending data and information concerning debt;
the second computer having a memory; and
a set of instructions stored in the memory that, when executed by the engine, cause the engine to:
receive, from user devices associated with a plurality of users, contestant information including information relating to each user's loan and/or loan provider,
register the plurality of users based on each user's contestant information and store such information,
provide the users with access to a sales platform,
receive, from the users via the sales platform, requests to purchase a plurality of tickets for a pool, wherein each of the plurality of tickets is assigned a unique identifier,
receive payment from the users,
assign to each of the plurality of users a ticket having a unique identifier,
determine whether a period of time is expired,
determine whether or not to extend the period of time once the period of time has expired,
when the period of time is extended receive from the users via the sales platform, requests to purchase a plurality of tickets for the pool, wherein each of the plurality of tickets is assigned the unique identifier,
deposit sale proceeds for the pool into a bank account,
transmit to a random and non-random selection system a message containing the plurality of unique identifiers participating in the pool,
receive from the random and non-random selection system a random selection message,
determine a winning ticket of the plurality of tickets based on the random selection message,
determine a winning user of the plurality of users based on the winning ticket,
verify the winning user's information relating to the winning user's loan provider,
receive a confirmation from the winning user,
request a transfer from the bank account to a third party having an account associated with a loan provider, and transferring a winning amount not based on pool size but based on winner's debt owed in order to transform debt into a payoff amount or credit.

30. A method for providing a debt repayment game, comprising the steps of:
qualifying a contestant with debt in an unrestrictive manner;
collecting proceeds based on a temporal variable from at least one of the contestant, benefactors, or third party to create a winning pool amount that may be monetary or non-monetary;
limiting the amount of investment a contestant can place at risk in the game to less than 0.5 or 50% of the debt owed by the contestant to prevent contestant material financial loss and contestant overspending in the game;
selecting at least one winner based on random or non-random factors;
determining a payout amount based on winner's debt owed instead of the winning pool amount;
giving the payout amount to a third party lender instead of the winner where the winner never obtains the payout amount; and
making a waterfall payout structure to guarantee the entire sum of the winning pool amount is paid out for every game if the winner's debt is lower than the winning pool amount.

31. A non-transitory computer readable medium for providing a debt repayment game, comprising:
instruction code for receiving and storing, by an engine, from user devices associated with a plurality of users, contestant information including information relating to each user's loan and/or loan provider;
instruction code for registering, by the engine, the plurality of users based on each user's contestant information;
instruction code for providing, by the engine, the users with access to a sales platform;
instruction code for receiving, by the engine, from the users via the sales platform, requests to purchase a plurality of tickets for a pool, wherein each of the plurality of tickets is assigned a unique identifier;
instruction code for receiving, by the engine, payment from the users;
instruction code for assigning, by the engine, to each of the plurality of users a ticket having a unique identifier;
instruction code for determining, by the engine, whether a temporal deadline has passed and whether or not to extend the temporal deadline;
instruction code for closing or extending the time to enter, by the engine, the pool based on determining the time designated for pool entry;
instruction code for depositing, by the engine, sale proceeds for the pool into a bank account;
instruction code for transmitting, by the engine, to a random selection system a message containing the plurality of unique identifiers participating in the pool;
instruction code for receiving, by the engine, a random selection message from the random selection system;
instruction code for determining, by the engine, a winning ticket of the plurality of tickets based on the random selection message;
instruction code for determining, by the engine, a winning user of the plurality of users based on the winning ticket;
instruction code for verifying, by the engine, the winning user's information relating to the winning user's loan provider;
instruction code for receiving, by the engine, a confirmation from the winning user; and
instruction code for requesting, by the engine, a transfer from the bank account to another account associated with the winning user's loan provider.

32. A method for providing a debt repayment game, comprising:
selecting for a game by a first computer from an unrestricted pool of players creating a pool size, each player having an existing loan debt; said first computer a specialized computer used in government or by financial institutions to generate loans;
a second computer controlled by said first computer through said selection, said second computer generating at least one winner from the pool of players by using at least one variable factor, said factor selected from the group consisting of a temporal variable, the pool size, and any combination thereof; and
paying a third party a winner proceeds based on the amount of debt owed by the at least one winner and not based on a winning pool amount; and said winner proceeds of the game for payment of said loan debt of said winner to transform debt into a payoff amount or credit.
